(19) United States
(12) Patent Application Publication
(10) Pub. No.: US 2009/0255146 A1
(43) Pub. Date: Oct. 15, 2009

(54) STEAM SUPPLYING METHOD AND TREATMENT APPARATUS

(75) Inventors: Hans-Joachim Klug, Winkelhaid (DE); Thomas Loy, Nurnberg (DE)

Correspondence Address: PEARNE & GORDON LLP, 1801 EAST 9TH STREET, SUITE 1200, CLEVELAND, OH, 44114-3108, US

(73) Assignee: Electrolux Home Products Corporation N.V., Zaventem (BE)

(21) Appl. No.: 12/302,628

(22) PCT Filed: Jun. 1, 2007
(86) PCT No.: PCT/EP07/04852

§ 371 Date: Nov. 26, 2008

(30) Foreign Application Priority Data
Jun. 1, 2006 (EP) 06011420.4
Jul. 31, 2006 (EP) 06015884.7

(51) Int. Cl. F26B 3/00; F26B 19/00; F26B 11/02

(52) U.S. Cl. 34/491; 34/495; 34/572; 34/132

(57) ABSTRACT

The invention relates to a method of supplying steam (38) to a fabrics storage compartment (6) of a treatment apparatus (2), in particular a dryer, a refreshment apparatus or a washing machine having drying function, comprising the steps of: flowing air through the storage compartment (6) until a predefined temperature and/or humidity has been effected; and supplying steam (38) at a predefined flow and/or temperature to the storage compartment (6). The invention also relates to a method of supplying steam (38) to a fabrics storage compartment (6) of a treatment apparatus (2), in particular a dryer, a refreshment apparatus or a washing machine having drying function, wherein the steam flow and/or the temperature of the steam (38) supplied into the storage compartment (6) is set in dependency of at least one process parameter.

The invention relates to a method of supplying steam into a fabrics storage compartment of a laundry treatment device, and a treatment apparatus having a control unit controlling the steam supply to the fabrics storage compartment.

In a conventional condenser dryer as proposed in DE 102 60 151 A1 a steam evaporating device is arranged in an air channel for supplying the circulated air into a drum. In the evaporating device the heat of a heater normally used for heating the circulated air heats and evaporates water which is supplied into a cup located in the air channel. During steam supply into the rotating drum, a fan in the circulation channel is operated such that the steam is blown from the channel into the drum. The efficiency of the steam supply is lowered in that the air is circulated through the drum such that a portion of the steam introduced into the drum is again flown out of the drum into the exit channel where it then may condensate at a condenser and other elements in the air passages. Further, the steam generated in the air channel can condense and inhomogeneously cool down at or close to the channel walls and the backside of the drum wall prior or during inlet into the drum.

It is an object of the invention to provide a steam supplying method for supplying steam to a fabric storage compartment and to provide a treatment apparatus in which at the one side the precision of the steam treatment is improved and on the other hand the risk of damage or negative effects on fabrics from steam treatment are reduced.

The invention is defined in claims 1, 3, 16 and 18, respectively. Particular embodiments are set out in the dependent claims.

It has been observed that when introducing the steam into the storage compartment of a treatment apparatus like a dryer at least a portion of the steam may condensate and form droplets, wherein the droplets formed in cold areas of the delivery path to the fabrics result in low temperature droplets or the condensation in areas of hot temperature steam supply may result in high temperature droplets. In both cases the contact of the fabrics to be treated with the steam droplets may result in adverse effect to the fabrics or to the efficiency of the fabrics treatment. Due to inhomogeneities in temperature and/or dampness at the locations where the droplets hit the fabrics or textiles as compared to areas where the textile is in contact with the hot steam only, significant differences in the steam treatment effect may arise. For example wrinkles may form due to different elasticity of the fabrics being non-uniformly dampened, partially overheating of the fabrics with the hot droplets, decoloration effects, different efficiencies of additives added to the steam treatment and the like may result. To avoid the formation of droplets, the inventors propose two solutions which are fully compatible with each other and which are preferably combined with each other. According to the first approach (claims 1 and 16) and before starting the steam supply into the storage compartment, optimum starting conditions are provided such that when starting the steam supply, the likelihood of droplet formation is significantly reduced. According to the other approach or solution (claims 3 and 18) the processing conditions in the storage compartment are directly or indirectly monitored and the steam supply parameters are adapted in dependency of the monitored internal conditions for droplet prevention.

According to claim 1, a steam supplying method is provided in which the steam is supplied into a fabrics storage compartment of a treatment apparatus. The treatment apparatus is for example a dryer or a washing machine providing refreshment functionality or any other treatment apparatus having a storage compartment through which air, preferably drying air, is ventilated. The steam supplying method can for example be implemented as a subroutine of a refreshment cycle, an anti-crease cycle during a drying procedure, or an anti-crease phase after the drying of the laundry stored in the storage compartment. Preferably the steam is supplied directly into the storage compartment. This means that the steam injection is made at a location having a direct and contact-free path from the point of injection to the storage compartment's inner volume. Alternatively but not preferably the steam may be supplied indirectly into the storage compartment, for example by injecting the steam into an air guiding channel connected to the storage compartment.

For preparing the start of the steam supply into the storage compartment, the air or drying air is blown through the storage compartment until a predefined temperature and/or humidity has been achieved. If for example dry laundry is loaded into the storage compartment, it is not required to dry the laundry by the air (in particular drying air) and instead the temperature of the laundry, the air passed through the storage compartment or circulated through the storage compartment, and elements in contact with the circulated or injected air are heated up to a predefined temperature. As the condensation effect is mainly induced by the contact or mixture of the steam with the air flowing through the storage compartment, of course the air temperature is the most relevant parameter in this case. Preferably, the predefined temperature is somewhat above typical ambient temperatures, for example about 35, 40 or 50° C. If the laundry or fabrics loaded into storage compartment is already wet or damp, for example after a previous washing process, the humidity of the air within the storage compartment and/or the humidity of the laundry is set to a predefined humidity level, for example a residual or relative humidity of 3%, 5% or 10%. Preferably, the predefined temperature and the predefined humidity are both set by the pre-drying process, as the steam condensation behavior depends on the air temperature as well as on the (already existing) air humidity.

The air ventilated through the storing compartment may be heated or cooled or neither nor (air with ambient or internal temperature is ventilated). Air heating is effected by activation of a heating device. Cooling is effected by activating a cooling device like a condenser (e.g. used in a condenser air dryer) and/or cold ambient air from outside the treatment apparatus is sucked into the treatment apparatus—at least partially forming the ventilated air.

According to claim 2 and after the starting phase of supplying steam into the storage compartment, the steam supply is continued wherein the steam flow and/or the temperature of the steam is set in dependency of at least one process parameter. This means that in this embodiment the steam supply is not continued with the predefined flow and/or temperature, but the flow and/or temperature is adjusted according to the current operation process parameters which may vary after having started the steam supply process. For example, the air humidity changes in the storage compartment after the steam supply has been started and at the same time the rate of change of the air humidity depends on the amount of laundry or fabrics loaded in the storage compartment and/or the type of fabrics stored therein. If, for example, the current process parameters change, the steam flow and/or the temperature are correspondingly adapted in reaction thereto such that the effect of avoiding the droplet formation during the steam supply is maintained even over a longer period of steam supply. A steam supply period lasts for example longer than one minute, two minutes, or lies in a range of three to seven minutes.

The subject matter of claim 3 also provides the effects and advantages of claim 2, while according to claim 3 it is not necessary that the steam supply sequence is started at a predefined temperature and/or humidity in the storing compartment. For example, the steam supply may be started with a very low steam supply rate which inherently avoids the risk of forming droplets, and then the steam supply flow rate can be increased in reaction to the detected process parameters allowing a higher steam flow rate. In an alternative embodiment for the starting phase, the steam supply sequence is started at a low level or from a zero steam flow rate and is successively increased to a predefined steam flow rate. Thereafter the steam flow rate is preferably adjusted according to claim 3.

The process parameters relevant for setting the steam flow and/or the temperature of the steam are one or more the following:
the air humidity, wherein the steam flow rate is for example decreased with increasing air humidity;
the air temperature, wherein the steam flow rate is for example increased with increasing air temperature;
the air temperature, wherein the steam temperature is reduced with increasing air temperature;
the air flow through the storage compartment, wherein the steam flow rate is increased with increasing flow through the storage compartment to compensate the effect of exhausting at least a portion of the supplied steam when circulating the air through the storage compartment; and
the rotation speed of a drum forming the storage compartment, wherein the steam flow rate is increased with increasing rotation speed which results in a higher redistribution rate of the laundry in the drum and a higher air agitation (at least as long the spinning speed is not reached and the laundry is tumbling within the drum).

According to a preferred embodiment, the approach to the predefined temperature or generally the current air temperature is detected in the storage compartment as the most relevant measurement location having an effect onto the steam condensation. Preferably the air temperature is detected at a surface or a wall of the air guiding and enclosing walls of the apparatus or fabrics storage compartment. For example the air temperature is detected at the storing compartment's surface or wall (e.g. drum wall). In alternative embodiments or in addition thereto the temperature can be measured in an air flow path or in an air circulation path or also preferably at a location close to the injection point for the steam supply.

Alternatively or additionally the air humidity is preferably detected at the same locations as the air temperature detection locations. Preferably the humidity is detected together with the temperature (at the same location), such that there is a direct correlation between the temperature and humidity at one location. Preferably, the humidity of the air is derived from the humidity detection of the laundry which is often implemented by an electrical conductivity measurement at the inner walls of the drum.

The values of the temperature and/or humidity for observing the approach to the predetermined temperature and/or predetermined humidity for adjusting the steam supply in dependency of these process parameters, are preferably detected or monitored periodically, permanently, intermittently or the like, such that the progress or changes in the process parameter conditions (e.g. temperature/humidity) can be steadily used to correct and optimize the steam flow and/or temperature. This is correspondingly valid for the other process parameters, if changing over time, and is considered for determining the steam flow and/or temperature.

Preferably in the method of claim 1 and the apparatus of claim 16 at least the predetermined steam flow rate (preferably also or alternatively the predetermined temperature) is calculated on the basis of the predefined air temperature and the predefined air humidity using the below formula for calculating the dew point. Preferably additional parameters are considered (which can partially be determined by experiments) in calculating or determining the predetermined flow rate (and the predetermined temperature), like the laundry weight, the drum volume, the temperature drop during transport of the steam from the steam supplying device to the injection point, the drum rotation speed and the like.

Correspondingly for the method of claim 3 and the apparatus of claim 18 the steam flow (and preferably also the steam temperature) are calculated on the basis of the detected air temperature and detected air humidity (the most relevant process parameters) the same way as for claims 1 and 16.

For example the following formula is convenient to calculate the dew point in degrees Celsius to within ±0.4° C. It is valid for 0° C.<T<60° C.; 0.01<RH<1.0; and 0° C.<Td<50° C.

where
T=temperature in degrees Celsius
RH=is the relative humidity as a fraction (not percent)
Td=the dew point temperature to be calculated
   and the formula is:

$${T}_{d} = \frac{b γ ( T , RH )}{a - γ ( T , RH )}$$

$$where$$

$$γ ( T , RH ) = \frac{aT}{b + T} + ln RH$$

and a=17.27, b=237.7° C., and in is the natural logarithm.

It is to be noted that the setting of the steam flow and/or the temperature of the steam supplied to the compartment in dependency of the drying process parameter(s) can be used for example for maximizing the steam flow up to a limit below the condensation or droplet forming such that due to the high steam flow rate the time required to supply a predefined steam amount into the compartment is reduced. Alternatively or additionally the temperature of the steam is minimized, for example, to reduce energy consumption during steam generation and/or to treat delicate textiles with steam at as low temperature as possible.

According to a preferred embodiment the steam flow rate and/or the temperature of the steam is adapted or set by setting a supplying flow rate of liquid to a first heating device of the steam generator. Or the heating activity of the steam generator is adapted in dependency of the predefined temperature and/or humidity or the monitored temperature and/or humidity during the steam supply sequence. For example, the liquid flow rate to the steam generator is increased to increase the steam flow rate while at the same time the heating power is increased to maintain the steam supply at a constant steam temperature.

In an embodiment the temperature of the steam can be monitored and the steam temperature signal can be used in a closed-loop configuration to adjust the heating and evaporation of the liquid for steam generation in dependency of the current steam temperature signal. Steam temperature is for example detected within the steam generator (steam supplying unit), at a pipe guiding the steam from the steam generator to the injection location, in or at a nozzle injecting the steam, or a combination of temperatures measured at these temperature detection locations.

In a preferred embodiment the air flow through the storage compartment is reduced or stopped such that the steam is not exhausted out of the storing compartment during air circulation or ventilation. This also avoids steam condensation outside the storage compartment.

In a further embodiment, the duration of steam supply and/or the total amount of steam supplied to the drum is set in dependency or is dependent of the process parameters, preferably the air temperature and/or the air humidity. The duration and/or steam amount may be set at the beginning of the steam supply phase, or preferably it is adjusted under continued monitoring of the process parameters which gives an indication when the steam treatment has reached a predetermined end level. For example the air temperature is allowed only to increase to a predetermined level during steam supply to avoid damages to the fabrics (e.g. the predetermined temperature level itself depends on the fabrics type). And/or a maximum air or laundry humidity represents an end point for steam supply.

The treatment apparatus according to claims 19 or 21 are provided with a control unit which is adapted to control or operate the treatment apparatus such that the effects described above in relation to the method claims are fully applicable also for the operation of the treatment apparatus using the respective functional components of the treatment apparatus.

Reference is made in detail to an exemplary embodiment of the invention, an example of which is illustrated in the accompanying drawings, which show:

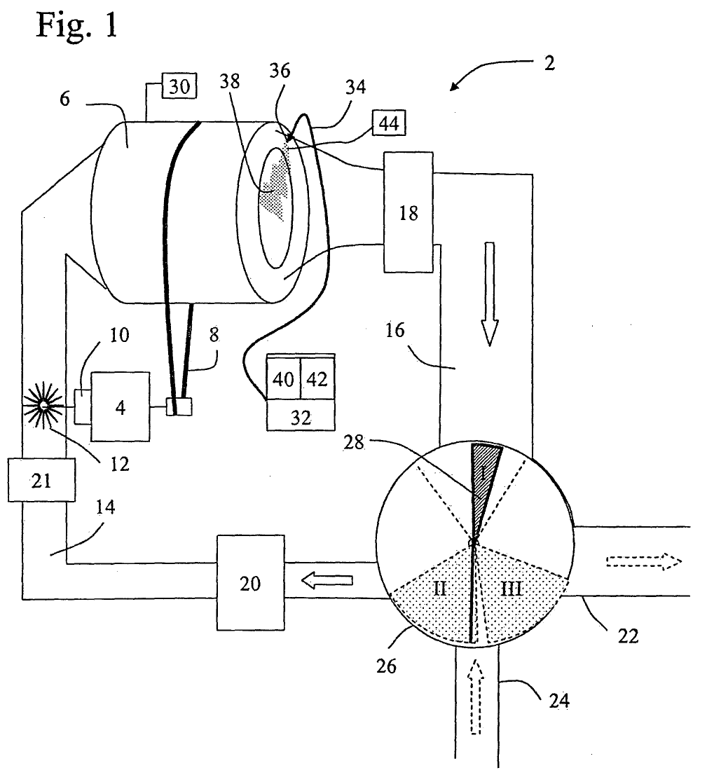

FIG. 1 an overview of functional elements of a dryer,

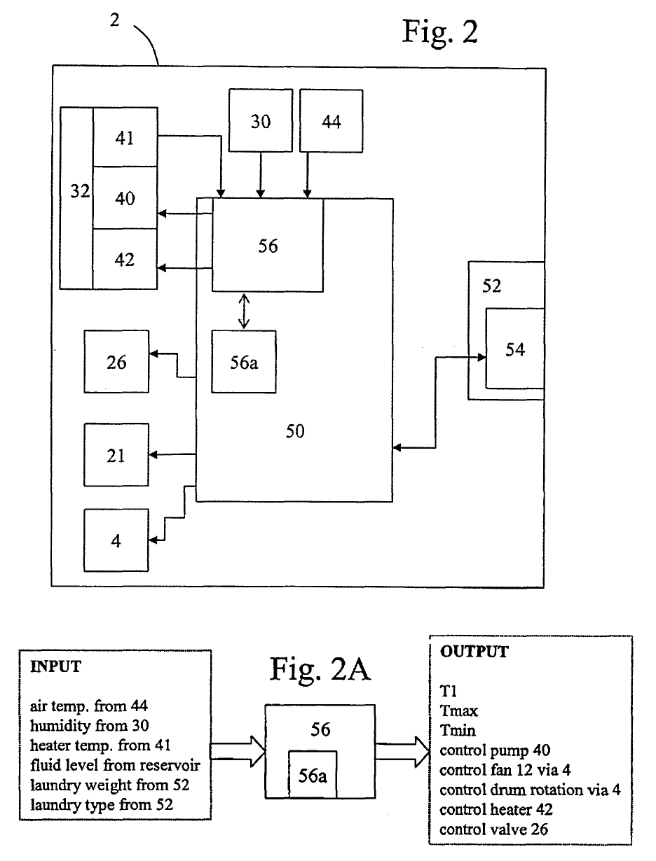

FIG. 2 a block diagram of signal and control transmissions between functional elements of the dryer,

FIG. 2A input/output parameters input to and output from a control unit; and

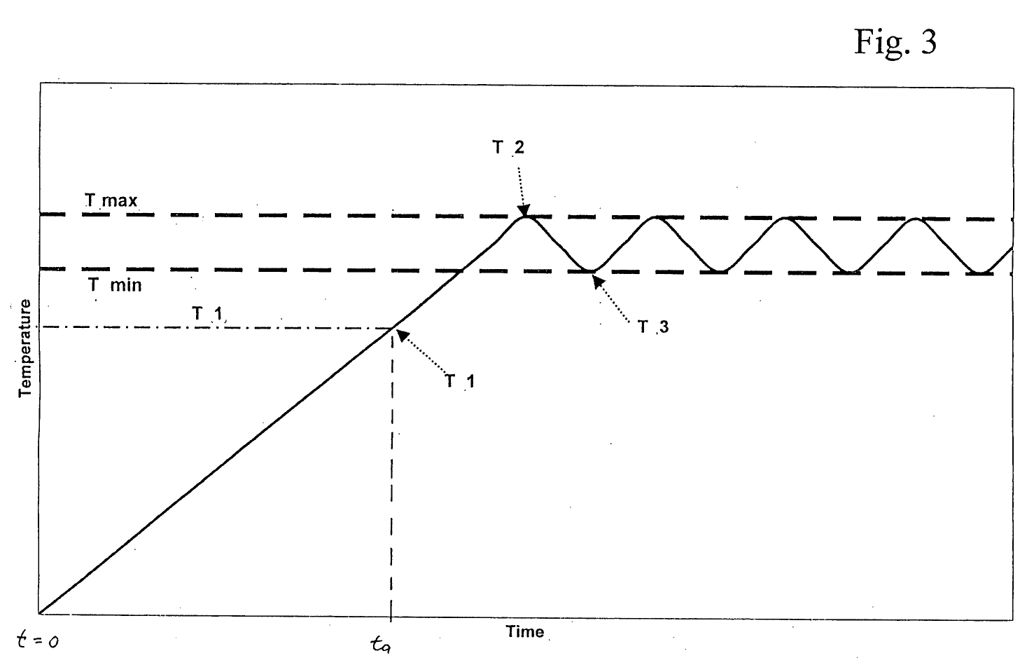

FIG. 3 a temperature profile over time of a heater element in a steam generator.

FIG. 1 schematically shows some functional elements of a tumble dryer 2. In the dryer 2 the laundry to be treated or dried is stored in a drum 6 driven by a motor 4 via a belt 8. Rotational speed and rotation direction of the motor 4 can be controlled by a control unit 50 (CPU) shown in FIG. 2. The motor rotation is coupled via a freewheel 10 to a fan 12 arranged in an inlet channel 14 for blowing air into the drum 6 in a forward rotation direction of the motor 4. In reverse rotation direction of the motor 4 the freewheel decouples the fan shaft from the motor shaft such that the fan 12 is not driven. The loading side of the drum 6 is connected to an outlet channel 16 wherein the exhaust air first passes a fluff filter 18 before entering into the outlet 16.

When operating in condenser mode, the air from the outlet channel 16 is passed through a condenser 20 from where the circulated air is further guided through a heater 21 and then it is passed to the inlet channel 14. In the present exemplary embodiment the tumble dryer 2 can be switched from a condensation mode, where the air is circulated in channels 14, 16 and drum 6, and an exhaust mode, where fresh air is sucked in through an intake channel 24 and the humidity laden air is exhausted through exhaust channel 22. Switching between condensation mode and exhaust mode is made by switching valve 26 under the control of the control unit 50. Any intermediate position between the two modes of circulation and condensation can also be switched to by correspondingly adjusting the position or alignment of a valve element 28 within the valve body 26. I.e. in the three positions I, II, III shown in FIG. 1, the condensation exclusive mode is achieved in position II of the valve element, the exhaust exclusive mode is achieved in position III of the valve element 28, and a mixed mode is achieved in position I of the valve element 28. It should be noted that the valve 26 could also be positioned between the condenser 20 and the heater 21.

The humidity of the laundry in the drum is detected by a humidity sensor 30 which is formed as a conductivity sensor. The conductivity sensor detects the electrical conductivity of the laundry between two metallic contacts at the drums inside which are spaced from each other. In alternate embodiments or in addition to the conductivity sensor the air humidity of the air flown through the drum 6 can be detected at another position in the air passage, for example at a location close to or at the fluff filter 18. Further, a second temperature sensor 44 is arranged at the loading opening of the drum to detect the temperature of the air within the drum. As shown, the temperature measure point is close to a nozzle 36 of an additive injector 32.

The additive injector 32 generates water steam which is supplied via supply line 34 to the nozzle 36 such that a steam jet 38 is injected into the drums inside. Under the control of the control unit 50, a pump 40 assigned to the additive injector 32 pumps water from a water reservoir (not shown) into the additive injector 32 in which a heating element 42 is arranged to evaporate the water. The power dissipated by heating element 42 is also controlled by control unit 50 such that steam flow rate and/or steam temperature are controlled by correspondingly setting the temperature within the additive injector 32 by heating the heating element 42 and by pumping a controllable flow of water into the additive injector 32 where the water is brought into contact with the heating element 42. The temperature within the additive injector 32 is detected close to the heating element 42 by a first temperature sensor 41.

In an embodiment not shown, the steam temperature is detected with an additional temperature sensor within the steam supply pipe 34 or temperature signal of the sensor 44 is taken as the steam temperature during steam supply phases (while it is e.g. taken as an air temperature signal in non-steam supply phases). The steam temperature signal thus detected is also supplied to the control unit 50 and processed there to adjust the steam temperature either by taking this signal exclusively to control operation the heating element 42 and thereby the steam temperature, or it is taken as a correction signal together with the temperature signal from the first temperature sensor 41 (FIG. 2) to control the operation of heating element 42.

FIG. 2 shows a block diagram of functional elements partially already shown in FIG. 1. The CPU 50 is connected to an input panel 52 and a display section 54, wherein the user can input program options and selections at the input panel 52. For example a refreshment program including or excluding a program option for an anti-crease phase may be selected. Also, a user input can be made whether the drying program or refreshment program should start with dry or with damp laundry. Further, the type of textiles can be input and also a weight, for example in form of a volume input by selecting between full, medium or low loaded drum.

As indicated by the arrows, the CPU 50 controls the operation of motor 4, heater 21, valve 26 and additive injector 32. Selected programs and program options can be indicated at the display section 54 under the control of the CPU 50. Also operating states of the dryer are indicated in the display section, for example the remaining time until finishing the program or the like. Via a subunit 56 the CPU 50 received measurement signals from the first temperature sensor 41, the second temperature sensor 44 and the humidity sensor 30. Of course, FIGS. 1 and 2 only show some of the functional elements and control and sensing paths which are additionally used in dryers.

For controlling and optimizing the steam supply into the drum during a steam supply phase and in preparation for a steam supply phase, the subunit 56 receives and processes the signals of the first and second temperature sensors and the humidity sensor 30. In a look-up memory 56a connected to the subunit 56 optimization patterns are deposited such that, by using the corresponding signals from sensors 30, 41 and 44, an optimum steam flow rate and temperature for supplying the steam into the drum 6 from the additive injector 32 is calculated. In the shown embodiment the ‘calculation’ means retrieval from look-up memory 56a storing a look-up table. Here the temperature and steam flow rate are adjusted by providing from the subunit 56 to the CPU 50 control signals which are forwarded to the pump 40 and the heating element 42. Thereby, the steam flow rate essentially depends on the heating power developed by heating element 42 and the pumping rate of pumping water by pump 40 to the heating element 42. Correspondingly, the steam temperature is a function of the heating power and the fluid flow rate generated by pump 40.

FIG. 3 shows a typical time behavior of the temperature in the additive injector 32 as detected by the first temperature sensor 41. If steam supply is required, at t=0 the heating of the heating element 42 is started by a respective control signal from CPU 50 (subunit 56). With the start of heating, the temperature goes up as detected with the first temperature sensor 41. At time tₐ the threshold temperature value T1 is reached and pump 40 is activated such that the water is pumped onto the heating element 42. The injector starts steam generation, wherein steam flow rate exiting the additive injector 32 and the steam temperature increase after time tₐ (from temperature T1) until an upper temperature value T2 is reached. At this time, when the temperature T2 is equal to the upper limit Tmax, the heating element 42 is switched off such that the temperature in the additive injector 32 decreases as detected with the first temperature sensor 41. The temperature falls to lower temperature T3 which lies at a lower temperature limit Tmin whereupon the heating element 42 is activated again and the temperature rises again up to Tmax. By this two-step control the temperature periodically swings between the lower limit Tmin and the upper limit Tmax as long as the steam supply is required and also as long as the limits Tmax, Tmin are not modified (see below). By this control an average steam flow and average steam temperature with only minimal deviations around the average values are achieved.

According to an exemplary embodiment of the invention, the threshold value T1 as well as the lower and the upper limits Tmin, Tmax itself are not fixed, but one, two or all three dependent on the processing conditions for processing the laundry. Together with adapting these (one, two or three) temperatures in dependency of the process parameters, the liquid flow rate generated by pump 40 is adapted such that the formation of droplets in the drum or at the nozzle 36 are avoided when the steam jet 38 is injected into the drum 6. This means that in the present exemplary embodiment dew point conditions are stored in look-up memory 56a, wherein on the basis of the detected air temperature (second temperature sensor 44) and the humidity (humidity sensor 30) an optimized pumping flow rate (pump 40) and heating power or temperature (e.g. temperature limits Tmin, Tmax) of the additive injector 32 (first temperature sensor 41) is adjusted and controlled such that finally an optimized steam temperature and steam flow rate of the steam exiting the nozzle 36 is effected avoiding the formation of droplets.

In another aspect of the invention, the starting conditions for supplying the steam from the additive injector 32 into the drum are selected such that droplet suppression is also achieved from the beginning. According to a first approach this can be made in that, prior to the start of the steam supply, a predefined condition in the drum is effected, for example by heating the air in the drum 6 to a predefined temperature and at the same time by pre-drying the laundry (if damp) to a predefined starting humidity (which can be detected either via the laundry's humidity or the air humidity). As soon as these predefined conditions have been achieved, the steam supply is started. According to a second approach (or additionally), the threshold temperature T1 for starting fluid supply to the heating element 42 is selected in dependency of the current conditions in the drum (air temperature and/or humidity) and also the upper and lower two-point control values Tmax and Tmin are selected in dependency of the initial conditions (temperature and/or humidity) in the drum 6. This means that by either way the risk of droplet forming in the starting phase of steam supply is significantly reduced.

It should be noted that according to an exemplary operation of the dryer 2 the flow of air through the drum 6 is stopped in that the fan 12 is decoupled from the reverse motor rotation via freewheel 10. In this case, the steam 38 injected by nozzle 36 is not blown out of the drum 6 and maximum steam efficiency is achieved at the laundry rotated in the drum via reverse drum rotation.

Of course, the operation conditions for the additive injector 32 are also optimized to avoid condensation within supply pipe 34 or at the nozzle 36 or inside the drum 6 at cold inner walls. The latter is avoided by the above mentioned pre-heating of the air via heater 21 and thereby pre-heating the laundry and also the drum material. Even if the air circulation is maintained during the steam supply phase, the steam parameters (temperature/flow rate) can be selected such that an adverse condensation rate at the condenser or heater 21 is avoided. The adaptation of the steam generation parameter in dependency of the processing conditions also takes into consideration deviations from identical processing runs, if for example an exhaust air mode is selected and ambient air with high humidity and high temperature is sucked and blown through drum 6.

### REFERENCE NUMERAL LIST

2 tumble dryer
4 motor
6 drum
8 belt
10 freewheel
12 fan
14 inlet channel
16 outlet channel
18 fluff filter
20 condenser
21 heater
22 exhaust channel
24 intake channel
26 valve
28 valve element
30 humidity sensor
32 additive injector
34 supply pipe
36 nozzle
38 steam jet
40 pump
41 first temperature sensor
42 heating element
44 second temperature sensor
50 CPU
52 input panel
54 display section
56 sub unit
56a look-up memory

1: Steam supplying method for supplying steam (38) to a fabrics storage compartment (6) of a treatment apparatus (2), in particular a dryer, a refreshment apparatus or a washing machine having drying function, comprising the steps of:
flowing air through the storage compartment (6), in particular hot or cold air, until a predefined temperature and/or humidity has been effected; and
supplying steam (38) at a predefined flow and/or temperature to the storage compartment (6).

2: Method according to claim 1, further comprising, after supplying the steam (38) at a predefined flow and/or temperature, setting the steam flow and/or the temperature of the steam (38) supplied into the storage compartment (6) in dependency of at least one process parameter.

3: Steam supplying method for supplying steam (38) to a fabrics storage compartment (6) of a treatment apparatus (2), in particular a dryer, a refreshment apparatus or a washing machine having drying function, wherein the steam flow and/or the temperature of the steam (38) supplied into the storage compartment (6) is set in dependency of at least one process parameter.

4: Method according to claim 2, further comprising, after setting the steam flow and/or the temperature of the steam (38) supplied into the storage compartment (6) in dependency of at least one drying process parameter, finishing the steam supply in dependency of at least one process parameter.

5: Method according to claim 2, wherein the at least one process parameter is at least one of the group of: the air humidity; the fabric's humidity; the air temperature; the temperature of the surface or wall of the storage compartment (6), in particular a drum surface temperature; the temperature of a pipe supplying the steam (38) to the injection location (36); an air flow through the storage compartment (6), and a rotation speed of a drum forming the storage compartment (6).

6: Method according to claim 1, wherein the predefined temperature and/or the air temperature is the temperature detected at least in one of the following locations: in the storage compartment (6); in an air channel (14) supplying the air to the storage compartment (6); in an air channel (16) exhausting the air from the storage compartment (6); in proximity to or at an injection location (36) for injecting the steam (38) into the air and/or the storage compartment (6); the temperature of the surface or wall of the storage compartment (6), in particular a drum surface temperature; and the temperature of a pipe supplying the steam (38) to the injection location (36).

7: Method according to claim 1, wherein at least the temperature and/or the humidity, in particular the air humidity and/or the air temperature, are monitored permanently, intermittently or periodically.

8: Method according to claim 7, wherein the air humidity is detected in the storage compartment (6), in an air channel (14) supplying the air to the storage compartment, in an air channel (16) exhausting the air from the storage compartment (6), or in proximity to or at an injection location (36) for injecting the steam (38) into the air and/or the storage compartment (6).

9: Method according to claim 7, wherein the humidity of the laundry is detected and the detected laundry humidity serves as a measure for the air humidity.

10: Method according to claim 5, wherein the flow of steam (38) supplied to the storage compartment (6) is increased the lower the detected air humidity is and/or is increased with increasing air temperature.

11: Method according to claim 5, wherein the flow of steam (38) supplied to the storage compartment (6) is decreased with increasing air humidity and/or decreasing air temperature.

12: Method according to claim 1, wherein in dependency of the temperature and the humidity a dew-point evaluation is performed and the flow and/or temperature of the steam (38) is adapted in dependency of the dew-point evaluation.

13: Method according to claim 1, wherein the flow of steam (38) is a flowrate of supplying the steam to the storage compartment (6) and/or the flow of steam is set by setting a fluid flowrate of the supply of a fluid to a first heating device (42) adapted to generate the steam flow.

14: Method according to claim 5, wherein the treatment apparatus (2) comprises a steam generating unit (32) and wherein the operation of the steam generation unit is adapted in dependency of the at least one process parameter.

15: Method according to claim 14, wherein the steam generating unit (32) has a hysteresis temperature work function or two-step control function and the hysteresis or the control function is adapted in dependency of the at least one drying process parameter, in particular the detected air humidity and/or the detected air temperature.

16: Fabrics treatment apparatus (2), in particular an exhaust air and/or condenser dryer, a refreshment apparatus or a washing machine having drying function, comprising:
a fabrics storage compartment (6) for storing fabrics to be treated;
a fan (12) for blowing air through the storage compartment (6), in particular drying air;
at least one steam supplying device (32) adapted to supply steam (38);
a detection unit (30, 44) adapted to detect the air humidity and/or air temperature; and
a control unit (50) adapted to control at least one fabrics pre-treatment sequence and at least one steam supply sequence subsequent to the at least one pre-treatment sequence;
wherein, in the at least one pre-treatment sequence, the control unit (50) is adapted to receive at least one signal from the detection unit (30, 44) indicating the air humidity and/or air temperature, and to control the fan (12) for blowing air through the storage compartment (6) until a predefined air temperature and/or air humidity has been effected; and
wherein the control unit (50) is adapted to control the at least steam supplying device (32) to supply steam (38) at a predefined flow and/or temperature.

17: Apparatus according to claim 16, wherein, after supplying the steam (38) at a predefined flow and/or temperature, the control unit (50) is adapted to control the steam flow and/or the temperature generated by the at least one steam supplying device (32) in dependency of at least one process parameter.

18: Fabrics treatment apparatus (2), in particular exhaust air and/or condenser dryer, refreshment apparatus or washing machine having drying function, comprising:
a fabrics storage compartment (6) for storing fabrics to be treated;
a fan (12) for blowing air through the storage compartment (6);
at least one steam supplying device (32) adapted to supply steam (38) to the storage compartment (6);
a detection unit (30, 44) adapted to detect the air humidity and/or air temperature; and
a control unit (50) adapted to control at least one steam supply sequence; wherein the control unit (50) is adapted to receive at least one signal from the detection unit (30, 44) indicating the air humidity and/or air temperature, and to control the steam flow and/or the temperature generated by the at least one steam supplying device (32) in dependency of at least one process parameter.

19: Apparatus according to claim 16, comprising a first heating device (21) adapted to heat the air to be blown into the storage compartment (6).

20: Apparatus according to claim 19, wherein the control unit (50) is adapted to control the first heating device (21) during the pre-treatment sequence to heat the air to be blown into the storage compartment (6).

21: Fabrics treatment apparatus according to claim 16, wherein, during the steam supply sequence, the control unit (50) is adapted to control the fan (12) and/or a shutter device (26) such that the air flow rate through the storing compartment (6) is reduced and/or the air flow direction is reversed, in particular the air flow rate is reduced to less than 50% of the nominal flow rate, preferably less than 70% or 85% of the nominal flow rate.

22: Fabrics treatment apparatus according to claim 16, wherein the at least one steam supplying device (32) comprises a second heating device (42) adapted to heat and evaporate at least one liquid supplied to the at least one steam supplying device.

23: Fabrics treatment apparatus according to claim 22, wherein the second heating device (42) is adapted to be controlled by the control unit (50).

24: Fabrics treatment apparatus according to claim 22, wherein the at least one steam supplying device (32) comprises a delivering means (40), in particular a valve or a pumping unit, adapted to supply at least one liquid to the second heating device (42).

25: Fabrics treatment apparatus according to claim 24, wherein the delivering means (40) is adapted to be controlled by the control unit, in particular the flow rate of the at least one liquid supplied to the second heating device is controllable by the control unit.

26: Fabrics treatment apparatus according to claim 16, wherein the steam flow, the steam supply duration, the steam total amount supplied during a steam treatment phase and/or the steam temperature is set in dependency of the type of fabrics to be treated and/or the volume or weight of the fabrics to be treated.

27: Fabrics treatment apparatus according to claim 16, wherein the storage compartment (6) is a rotatable drum.

28: Fabrics treatment apparatus according to claim 16, wherein the air flowable through the storage compartment (6) is an exhaust air stream or a circulation air stream.

29: Fabrics treatment apparatus according to claim 16, wherein the supplied steam (38) is one or more of the following: water steam, water steam comprising additives, disinfectant steam, perfume steam, detergent steam, deodorizing steam; and softener steam; wherein in particular the additive is one or more of the following: a disinfectant, a perfume, a detergent, a deodorizer, and a softener.
